(19) United States
(12) Patent Application Publication
(10) Pub. No.: US 2008/0175506 A1
(43) Pub. Date: Jul. 24, 2008

(54) IMAGE PROCESSING DEVICE, ELECTRONIC INSTRUMENT, AND METHOD OF CALIBRATING ANTI-ALIASING FILTER

(75) Inventor: Katsuya Ota, Shiojiri-shi (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 12/016,208

(22) Filed: Jan. 18, 2008

(30) Foreign Application Priority Data
Jan. 19, 2007 (JP) 2007-10571
Jan. 15, 2008 (JP) 2008-5602

(51) Int. Cl. G06K 9/40

(52) U.S. Cl. 382/254

(57) ABSTRACT

An image processing device includes: an anti-aliasing filter, a cutoff frequency of the anti-aliasing filter being variable; an analog-digital (AD) converter which converts an analog signal output from the anti-aliasing filter into a digital signal, and outputs the digital signal; and a filter calibration unit which calibrates the cutoff frequency of the anti-aliasing filter. The filter calibration unit calibrates the cutoff frequency of the anti-aliasing filter based on an output from the AD converter when a predetermined test image signal is input to the anti-aliasing filter.

Japanese Patent Application No. 2007-10571, filed on Jan. 19, 2007, and Japanese Patent Application No. 2008-5602, filed on Jan. 15, 2008, are hereby incorporated by reference in their entirety.

### BACKGROUND OF THE INVENTION

The present invention relates to an image processing device, an electronic instrument, and a method of calibrating an anti-aliasing filter.

The quality of a display image is important for an electronic instrument (e.g., projector) which displays an image. Therefore, an image processing circuit incorporated in such an electronic instrument must be configured so that noise is not superimposed on an input image signal. When an analog image signal is input to the image processing circuit, an AD converter converts the analog image signal into a digital image signal and then subjected to various types of digital image processing so that the quality of a display image does not deteriorate. In this case, when noise containing a frequency component at a frequency equal to or higher than a Nyquist frequency (i.e., half the sampling frequency of the AD converter) has been superimposed on the input analog image signal, due to sampling, the quality of the display image deteriorates with the noise folded into band of the input analog image signal. It is impossible to remove noise which has folded and been superimposed on the image signal. Therefore, it is necessary to remove noise containing a frequency component at a frequency equal to or higher than the Nyquist frequency before the analog image signal is input to the AD converter. In order to remove such noise, an anti-aliasing filter is used. The anti-aliasing filter has a low-pass characteristic which allows only an image signal within the desired band to pass through.

On the other hand, it is desirable that the sampling frequency be as low as possible in order to reduce the cost of the AD converter. In many cases, a frequency twice the highest frequency within the desired band may be selected as the sampling frequency. Therefore, it is ideal that the anti-aliasing filter have a low-pass characteristic which allows a signal at a frequency equal to or lower than the Nyquist frequency to pass through and blocks noise at a frequency higher than the Nyquist frequency. Specifically, a steep filter characteristic is desired for the anti-aliasing filter. However, since the anti-aliasing filter is formed of an analog circuit including a resistor, a capacitor, and the like, the cutoff frequency of the anti-aliasing filter may change due to variations in the resistance of the resistor and the capacitance of the capacitor. When the cutoff frequency decreases, an image signal at a frequency near the Nyquist frequency is attenuated. When the cutoff frequency increases, noise at a frequency near the Nyquist frequency cannot be completely removed.

Therefore, the target cutoff frequency has been determined with a large margin so that the image signal is not attenuated even if the cutoff frequency changes due to a variation during production, for example. However, since the quality of the display image deteriorates when noise which folds over to the desired band cannot be completely removed, pass/fail determination conditions before shipment must be tightened in order to maintain the quality of the display image. This reduces the yield of non-defective products, whereby the production cost increases.

Moreover, even if the quality of the display image is maintained by tightening the pass/fail determination conditions before shipment, the cutoff frequency of the anti-aliasing filter may change due to a change in the resistance of the resistor and the capacitance of the capacitor with the lapse of time, whereby the image quality may deteriorate.

In order to solve the above problems, JP-A-11-284510 discloses a signal processing device which makes it unnecessary to provide an anti-aliasing filter. This signal processing device has a configuration in which an analog signal is input to an AD converter through an integrator, and the output from the AD converter is differentiated.

Although this signal processing device does not require an anti-aliasing filter, oversampling is necessary by increasing the sampling frequency of the AD converter in order to sufficiently attenuate noise outside the band. Therefore, this signal processing device cannot be used when the AD converter samples the image signal at a frequency twice the highest frequency of the image signal. Moreover, since the integrator and a differentiator are required, cost may increase as compared with the case of using an anti-aliasing filter.

### SUMMARY

According to a first aspect of the invention, there is provided an image processing device comprising:

an anti-aliasing filter, a cutoff frequency of the anti-aliasing filter being variable;

an analog-digital (AD) converter which converts an analog signal output from the anti-aliasing filter into a digital signal, and outputs the digital signal; and

a filter calibration unit which calibrates the cutoff frequency of the anti-aliasing filter based on an output from the AD converter when a predetermined test image signal is input to the anti-aliasing filter.

According to a second aspect of the invention, there is provided an electronic instrument comprising the above-described image processing device, an input unit which inputs an image signal, and a display unit which displays the image signal.

According to a third aspect of the invention, there is provided a method of calibrating an anti-aliasing filter which variably controls a cutoff frequency based on a setting value, the method comprising:

switching a mode from a normal operation mode for performing normal image signal processing to a filter calibration mode for calibrating the cutoff frequency of the anti-aliasing filter based on a predetermined event; and

calibrating the cutoff frequency of the anti-aliasing filter by changing the setting value when a difference between the cutoff frequency of the anti-aliasing filter and a target cutoff frequency has been determined not to be within a predetermined range based on a digital signal obtained by analog-digital-conversion of an analog signal output from the anti-aliasing filter when a predetermined test image signal has been input to the anti-aliasing filter.

### BRIEF DESCRIPTION OF THE SEVERAL VIEWS OF THE DRAWING

FIG. 1 is a functional block diagram showing an image processing device according to one embodiment of the invention.

FIG. 2 shows another example of a functional block diagram of an image processing device according to one embodiment of the invention.

FIG. 3 shows a further example of a functional block diagram of an image processing device according to one embodiment of the invention.

FIG. 4A is a diagram showing a configuration example of an anti-aliasing filter (low-pass filter) of which the cutoff frequency can be variably controlled, and FIG. 4B is a diagram showing another configuration example of an anti-aliasing filter (low-pass filter) of which the cutoff frequency can be variably controlled.

FIG. 5 is a flowchart illustrative of an example of the flow of calibrating the cutoff frequency of an anti-aliasing filter before shipment.

FIG. 6 is a flowchart illustrative of an example of the flow of repeating calibration of the cutoff frequency of an anti-aliasing filter after calibrating the cutoff frequency of the anti-aliasing filter.

FIG. 7 is a flowchart illustrative of an example of the flow of calibrating the cutoff frequency of an anti-aliasing filter when an image processing device according to one embodiment of the invention includes a test image signal generation unit.

FIG. 8 is a block diagram showing a configuration example of a projector as an example of an electronic instrument according to one embodiment of the invention.

FIG. 9 shows another example of a functional block diagram of an image processing device according to one embodiment of the invention.

FIG. 10 shows yet another example of a functional block diagram of an image processing device according to one embodiment of the invention.

### DETAILED DESCRIPTION OF THE EMBODIMENT

The invention may provide an image processing device which can more easily reduce deterioration in image quality taking into account variation in cutoff frequency of an anti-aliasing filter during production and a change in cutoff frequency of an anti-aliasing filter with the lapse of time.

(1) According to one embodiment of the invention, there is provided an image processing device comprising:

an anti-aliasing filter, a cutoff frequency of the anti-aliasing filter being variable;

an analog-digital (AD) converter which converts an analog signal output from the anti-aliasing filter into a digital signal, and outputs the digital signal; and

a filter calibration unit which calibrates the cutoff frequency of the anti-aliasing filter based on an output from the AD converter when a predetermined test image signal is input to the anti-aliasing filter.

The filter calibration unit may be implemented by causing a CPU to execute calibration software stored in a ROM, or may be implemented by dedicated hardware, for example.

According to this embodiment, the cutoff frequency of the anti-aliasing filter can be calibrated for each image processing device during inspection before shipment of the image processing device according to this embodiment with regard to variations in the resistance of a resistor and the capacitance of a capacitor included in the anti-aliasing filter. This makes it possible to increase the yield of non-defective image processing devices which satisfy the specification relating to the filter characteristics of the anti-aliasing filter.

According to this embodiment, the cutoff frequency of the anti-aliasing filter can be easily calibrated for each image processing device when correcting the image processing device according to this embodiment with regard to variations in the resistance of a resistor and the capacitance of a capacitor included in the anti-aliasing filter with the lapse of time. Therefore, since the image processing device can be corrected without replacing the anti-aliasing filter by another anti-aliasing filter, the time and cost required for the repair work can be reduced.

The anti-aliasing filter may or may not be included in the image processing device according to this embodiment. The image processing device according to this embodiment may be implemented by one integrated circuit, or may be implemented by using a plurality of integrated circuit devices.

According to this embodiment, since the cutoff frequency of the anti-aliasing filter is calibrated based on the digital signal output from the AD converter, a dedicated circuit which detects the analog signal output from the anti-aliasing filter is unnecessary. For example, since a CPU can analyze the digital signal output from the AD converter and calculate the cutoff frequency based on the present setting value, the calibration process can be easily performed.

(2) The image processing device may comprise:

a comparison unit which compares the output from the AD converter when the predetermined test image signal is input to the anti-aliasing filter with calibration reference data for the cutoff frequency,

the filter calibration unit calibrating the cutoff frequency based on a comparison result of the comparison unit.

(3) In this image processing device, the filter calibration unit may calibrate the cutoff frequency of the anti-aliasing filter by changing a setting value of the cutoff frequency when the filter calibration unit has determined that a difference between the cutoff frequency and a target cutoff frequency is not within a predetermined range.

Whether or not the difference between the cutoff frequency of the anti-aliasing filter and the target cutoff frequency is within the predetermined range may be determined by inputting a test image signal at a frequency near the target cutoff frequency to the anti-aliasing filter and determining the attenuation factor of the output signal from the anti-aliasing filter, for example. Alternatively, the attenuation factor may be calculated from the output signal (analog signal) from the anti-aliasing filter, or may be calculated from a digital signal obtained by subjecting the output signal from the anti-aliasing filter to AD conversion, for example.

When it has been determined that the difference between the cutoff frequency of the anti-aliasing filter and the target cutoff frequency is not within the predetermined range, the setting value may be changed to a minimum extent, or a setting value which causes the difference in cutoff frequency to fall within the predetermined range may be directly calculated, and the setting value may be changed to the calculated value, for example. The test image signal may be input again after changing the setting value to check the calibration result.

(4) In this image processing device, the filter calibration unit may write a setting value of the calibrated cutoff frequency of the anti-aliasing filter into a nonvolatile memory.

According to this embodiment, when the cutoff frequency of the anti-aliasing filter has been calibrated, the setting value after calibration is stored in the nonvolatile memory. Therefore, the setting value after calibration can be stored after removing power. This makes it unnecessary to perform the calibration process each time power is supplied.

(5) In this image processing device, the predetermined test image signal may represent an image of two colors, the two colors being alternately represented in pixel units in the image.

According to this embodiment, the test image signal alternately represents two colors in pixel units (i.e., image signal containing only a highest-frequency component). Therefore, since an image signal having only a frequency closest to the cutoff frequency of the anti-aliasing filter is used, the calibration process can be easily performed.

(6) In this image processing device, the two colors of the image represented by the test image signal may be white and black.

According to this embodiment, the test image signal alternately represents white and black in pixel units (i.e., image signal containing only a highest-frequency component and having the largest amplitude). Therefore, since an image signal having only a frequency closest to the cutoff frequency of the anti-aliasing filter and having the largest amplitude is used, the calibration process can be easily performed.

(7) The image processing device may comprise:

a mode switch unit which switches a mode of the image processing device from a normal operation mode for performing normal image signal processing to a filter calibration mode for calibrating the cutoff frequency of the anti-aliasing filter based on a predetermined event.

(8) The image processing device may comprise:

an input select unit which selects an image signal to be supplied to the anti-aliasing filter,

wherein the filter calibration unit includes a test image signal generation unit which generates the predetermined test image signal, controls the input select unit so that the input select unit selects the predetermined test image signal generated by the test image signal generation unit in the filter calibration mode, and controls the input select unit so that the input select unit selects an externally supplied image signal in the normal operation mode.

According to this embodiment, the calibration process can be performed in the filter calibration mode using the test image signal generated in the image processing device according to this embodiment. Therefore, since the test image signal need not be supplied from the outside, the image processing device according to this embodiment can automatically perform the calibration process at a predetermined timing during startup after power is supplied to the image processing device, for example. Therefore, even if the cutoff frequency of the anti-aliasing filter changes with the lapse of time, the calibration process can be automatically performed without repair.

(9) In this image processing device,

the mode switch unit may switch the mode of the image processing device from the normal operation mode to the filter calibration mode when a predetermined condition has been satisfied during startup after power has been supplied to the image processing device, and switch the mode of the image processing device from the filter calibration mode to the normal operation mode when the filter calibration unit has completed calibration of the cutoff frequency of the anti-aliasing filter.

According to this embodiment, the image processing device is automatically set in the filter calibration mode when a predetermined condition has been satisfied during startup after power is supplied to the image processing device. Therefore, since the filter calibration process can be performed only when a predetermined condition has been satisfied, it is unnecessary to perform the calibration process each time the image processing device is activated. For example, the calibration process may be performed each time a predetermined period of time has elapsed after the image processing device according to this embodiment has been used. Or, the startup count value may be stored to a nonvolatile memory, and the calibration process may be performed each time a predetermined count value has been reached. Moreover, since the calibration process is performed during startup after power is supplied to the image processing device, the calibration process can be performed effectively utilizing the startup time when incorporating the image processing device according to this embodiment in an instrument which takes time for startup.

(10) According to one embodiment of the invention, there is provided an electronic instrument comprising the above-described image processing device, an input unit which inputs an image signal, and a display unit which displays the image signal.

The electronic instrument according to this embodiment can calibrate the cutoff frequency of the anti-aliasing filter effectively utilizing the period of time until a stable operation is achieved after startup. When the electronic instrument includes a mechanism which measures the service time or the like, the calibration process may be performed each time the service time or the like has reached a predetermined value. For example, when the electronic instrument is a projector, the calibration process may be performed effectively utilizing the period of time until a lamp is turned ON after startup, or may be performed each time the lamp has been turned ON for a predetermined period of time.

(11) According to one embodiment of the invention, there is provided a method of calibrating an anti-aliasing filter which variably controls a cutoff frequency based on a setting value, the method comprising:

switching a mode from a normal operation mode for performing normal image signal processing to a filter calibration mode for calibrating the cutoff frequency of the anti-aliasing filter based on a predetermined event; and

calibrating the cutoff frequency of the anti-aliasing filter by changing the setting value when a difference between the cutoff frequency of the anti-aliasing filter and a target cutoff frequency has been determined not to be within a predetermined range based on a digital signal obtained by analog-digital-conversion of an analog signal output from the anti-aliasing filter when a predetermined test image signal has been input to the anti-aliasing filter.

The image processing device according to this embodiment may be an image processing device which subjects an externally supplied image signal to a predetermined process and generates an image signal to be displayed on an external display device, wherein the image processing device may include a filter calibration unit which determines whether or not a difference between a cutoff frequency of an anti-aliasing filter and a target cutoff frequency is within a predetermined range based on an output signal output from the anti-aliasing filter when a predetermined test image signal is input to the anti-aliasing filter of which the cutoff frequency can be variably controlled, and calibrates the cutoff frequency of the anti-aliasing filter by changing the setting value when the filter calibration unit has determined that the difference between the cutoff frequency of the anti-aliasing filter and the target cutoff frequency is not within the predetermined range.

In the image processing device according to this embodiment, the filter calibration unit may calibrate the cutoff frequency of the anti-aliasing filter based on an output from an AD converter which converts an analog signal output from the anti-aliasing filter into a digital signal, and write the setting value into a nonvolatile memory at a predetermined timing.

The embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

1. Image Processing Device and Method of Calibrating Anti-Aliasing Filter

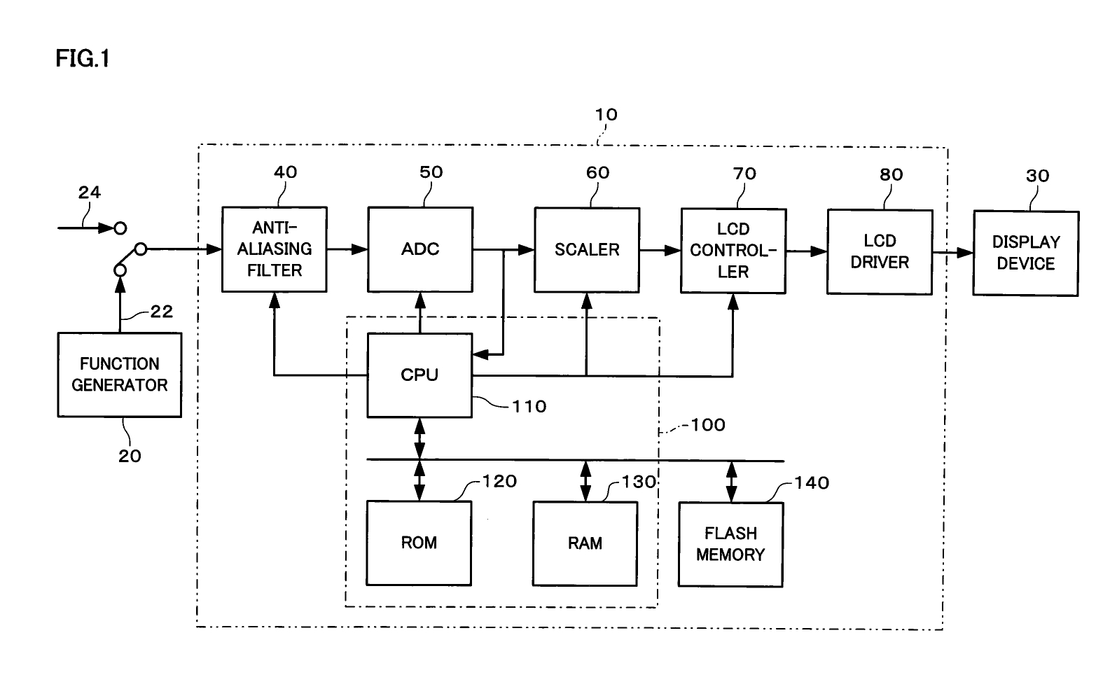

FIG. 1 is a functional block diagram showing an image processing device according to one embodiment of the invention. An anti-aliasing filter 40 removes a signal component contained in an input image signal and having a frequency higher than a Nyquist frequency which causes noise to fold over (aliasing) due to sampling performed by an AD converter 50. The sampling frequency of the AD converter 50 must be equal to or higher than a value twice the highest frequency of the signal component contained in the input image signal. The highest frequency of the signal component contained in the image signal differs depending on the image signal standard. For example, the highest frequency of the signal component contained in the image signal differs depending on the standard such as 480i, 480p, 720p, 1080i, and 1080p. This makes it necessary to change the cutoff frequency of the anti-aliasing filter 40 corresponding to the standard applied to the input image signal. For example, the highest frequency of the signal component contained in the image signal according to the 480i standard is 6.75 MHz. When the sampling frequency of the AD converter 50 is set at 13.5 MHz (6.75×2 MHz), it is desirable that the anti-aliasing filter 40 have a steep filter characteristic so that a signal component at a frequency equal to or less than 6.75 MHz passes through and the cutoff frequency is set at a frequency slightly higher than 6.75 MHz. The highest frequency of the signal component contained in the image signal according to the 480p standard is 13.5 MHz. When the sampling frequency of the AD converter 50 is set at 27 MHz (13.5×2 MHz), it is desirable that the anti-aliasing filter 40 have a steep filter characteristic so that a signal component at a frequency equal to or less than 13.5 MHz passes through and the cutoff frequency is set at a frequency slightly higher than 13.5 MHz. Therefore, when an image processing device deals with a plurality of standards, the anti-aliasing filter 40 must be set corresponding to the standard applied to the input image signal so that the cutoff frequency is set at a desired frequency, for example. The anti-aliasing filter 40 may or may not be included in an image processing device 10.

The image processing device 10 may include the AD converter 50. The AD converter 50 converts an analog signal output from the anti-aliasing filter 40 into a digital signal. For example, when the AD converter 50 is an 8-bit AD converter, the AD converter 50 converts an analog signal output from the anti-aliasing filter 40 into an 8-bit digital signal (0 to 255) in each sampling cycle.

The image processing device 10 may include a scaler 60, an LCD controller 70, and an LCD driver 80. The scaler 60 performs an image size adjustment process or the like on the output signal from the AD converter 50 according to an instruction from a CPU 110. The LCD controller 70 corrects the output signal from the scaler 60 according to an instruction from the CPU 110, for example, and supplies the resulting image signal to the LCD driver 80. The LCD driver 80 drives a display device 30 (e.g., liquid crystal panel) to display an image corresponding to the image signal supplied from the LCD controller 70.

The image processing device 10 includes a filter calibration unit 100. The filter calibration unit 100 calibrates the cutoff frequency of the anti-aliasing filter 40 of which the cutoff frequency can be variably changed based on a setting value. Specifically, the filter calibration unit 100 determines whether or not the difference between the cutoff frequency of the anti-aliasing filter 40 and the target cutoff frequency is within a predetermined range based on the output signal from the anti-aliasing filter 40 when a predetermined test image signal 22 is input to the anti-aliasing filter 40 from a function generator 20, for example. When the filter calibration unit 100 has determined that the difference between the cutoff frequency of the anti-aliasing filter 40 and the target cutoff frequency is within a predetermined range, the filter calibration unit 100 calibrates the cutoff frequency of the anti-aliasing filter 40 by changing the setting value. For example, the filter calibration unit 100 may calibrate the cutoff frequency of the anti-aliasing filter 40 based on the output from the AD converter 50 when the test image signal 22 is input to the anti-aliasing filter 40.

The filter calibration unit 100 may include the CPU 110, a ROM 120, and a RAM 130, for example. The ROM 120 stores a normal image processing program and a filter calibration program. When the image processing device 10 is set in a normal operation mode for performing normal image signal processing, the CPU 110 reads the normal image processing program from the ROM 120 and executes the normal image processing program. When the image processing device 10 is set in a filter calibration mode for calibrating the cutoff frequency of the anti-aliasing filter 40, the CPU 110 reads the filter calibration program from the ROM 120 and executes the filter calibration program.

The CPU 110 may also function as a comparison unit which compares the output from the AD converter 50 when the test image signal 22 is input to the anti-aliasing filter 40 with calibration reference data for the cutoff frequency of the anti-aliasing filter 40. The filter calibration unit 100 may calibrate the cutoff frequency of the anti-aliasing filter 40 based on the comparison result of the CPU 110 (comparison unit).

For example, an expected value (e.g., maximum value or root-mean-square value) of the amplitude level of the output from the AD converter 50 when a test image signal corresponding to each standard (e.g., 480i, 480p, 720p, 1080i, or 1080p) is input to the anti-aliasing filter 40 may be stored in advance in the ROM 120 or the like as the calibration reference data corresponding to each standard. When the image processing device 10 is set in the filter calibration mode, the CPU 110 may read the corresponding calibration reference data from the ROM 120 or the like at a predetermined timing, and may compare the maximum value, the root-mean-square value, or the like of the amplitude level of the output from the AD converter 50 with the calibration reference data. The filter calibration unit 100 (CPU 110) may calibrate the cutoff frequency of the anti-aliasing filter 40 by changing the setting value so that the cutoff frequency of the anti-aliasing filter 40 increases when the maximum value, the root-mean-square value, or the like of the amplitude level of the output from the AD converter 50 is smaller than the calibration reference data, and changing the setting value so that the cutoff frequency of the anti-aliasing filter 40 decreases when the maximum value, the root-mean-square value, or the like of the amplitude level of the output from the AD converter 50 is larger than the calibration reference data, for example.

The CPU 110 may function as a mode switch unit which switches the mode of the image processing device 10 from the normal operation mode to the filter calibration mode based on a predetermined event. The image processing device 10 may be set in the filter calibration mode based on an external command input or an external terminal setting as the predetermined event, or may be automatically set in the filter calibration mode when power is supplied to the image processing device 10, for example.

The input signal is switched outside the image processing device 10 so that a normal image signal 24 is input to the anti-aliasing filter 40 when the image processing device 10 is set in the normal operation mode, and the test image signal 22 output from the function generator 20 is input to the anti-aliasing filter 40 when the image processing device 10 is set in the filter calibration mode. When the image processing device 10 is set in the filter calibration mode, the test image signal 22 is input to the anti-aliasing filter 40, and the AD converter 50 converts the output signal from the anti-aliasing filter 40 into a digital signal. The test image signal converted into the digital signal is written into a frame buffer in the storage area of the RAM 130. The CPU 110 reads the test image signal written into the frame buffer at a predetermined timing based on the filter calibration program, and determines the cutoff frequency corresponding to the present setting value. When the CPU 110 has determined that the difference between the present cutoff frequency and the target cutoff frequency is not within a predetermined range, the CPU 110 changes the setting value. The setting value may be changed using various methods. For example, when the cutoff frequency is lower than a calibration target value, the setting value may be incremented or decremented by one so that the cutoff frequency increases. When the cutoff frequency is higher than the calibration target value, the setting value may be incremented or decremented by one so that the cutoff frequency decreases. Alternatively, the cutoff frequency corresponding to the present setting value may be determined, and a setting value which causes the cutoff frequency to coincide with the calibration target value may be directly calculated.

As described above, when an image processing device deals with a plurality of standards, the anti-aliasing filter 40 must be set corresponding to the standard applied the input image signal so that the cutoff frequency is set at a desired frequency. This makes it necessary to calibrate the cutoff frequency of the anti-aliasing filter 40 corresponding to the standard applied to the input image signal. When the sampling frequency of the AD converter 50 and the cutoff frequency of the anti-aliasing filter 40 have a linear relationship, the cutoff frequency of the anti-aliasing filter 40 may be calibrated while inputting a test image signal containing a highest-frequency component corresponding to one standard, and calibrated setting values corresponding to other standards may be directly calculated from the calibration result. When the sampling frequency of the AD converter 50 and the cutoff frequency of the anti-aliasing filter 40 do not have a linear relationship, the calibration process may be performed for each standard to determine the setting value.

When the AD converter 50 performs AD conversion at a sampling frequency twice the highest frequency of the image signal, it is desirable that the anti-aliasing filter 40 have a filter characteristic as steep as possible. On the other hand, since it is costly to design a filter having a steep filter characteristic, a filter having gentle filter characteristics may be designed. For example, since the highest frequency of the component of the 480i image signal is 6.75 MHz, a filter is designed to have a cutoff frequency slightly higher than 6.75 MHz. As a result, a noise component at a frequency equal to or higher than 6.75 MHz may not be sufficiently attenuated, whereby the filter may not sufficiently function as an anti-aliasing filter. In this case, a low-pass filter may be designed so that the upper limit of the passband is lower than 6.75 MHz (i.e., the cutoff frequency is about 6.75 MHz). In this case, a component of the image signal at a frequency around 6.75 MHz is attenuated. On the other hand, a noise component at a frequency equal to or higher than 6.75 MHz can be sufficiently attenuated. Therefore, the target cutoff frequency is determined corresponding to each image processing device depending on whether prevention of attenuation of the image signal or removal of fold-over noise is given priority. For example, the target cutoff frequency may be determined so that the highest-frequency component of the image signal is attenuated by 0.1 dB.

A flash memory 140 functions as a nonvolatile memory. The CPU 110 performs the calibration process based on the filter calibration program, and writes the setting value into a predetermined storage area of the flash memory 140 at a predetermined timing. The CPU 110 may write the setting value only once upon completion of the calibration process, or may write the setting value each time the setting value is changed. When the image processing device 10 is then set in the normal operation mode, the cutoff frequency of the anti-aliasing filter 40 is controlled based on the setting value written into the flash memory 140. For example, the CPU 110 may read the setting value after calibration from a predetermined storage area of the flash memory 140 and set the anti-aliasing filter 40 based on a startup program each time power is supplied to the image processing device 10.

The test image signal 22 may be an image signal which allows the cutoff frequency of the anti-aliasing filter 40 to be determined in the filter calibration mode. For example, the test image signal 22 may be an image signal which represents only two colors (i.e., white and black) and alternately represents the two colors in pixel units. Since the test image signal is an image signal containing only the highest-frequency component, the cutoff frequency of the anti-aliasing filter 40 can be determined. For example, when the anti-aliasing filter 40 is designed so that the highest-frequency component of the image signal is attenuated by 0.1 dB, the white level is attenuated by 0.1 dB when the test image signal passes through the anti-aliasing filter 40. The black level and the white level without attenuation are respectively 0 and 255 when the output of the anti-aliasing filter 40 is converted into a digital value using the 8-bit AD converter. When the test image signal which has passed through the anti-aliasing filter 40 is subjected to AD conversion, the black level remains 0 while the white level is attenuated to about 252. Since the attenuation curve of the filter characteristic of the anti-aliasing filter 40 is uniquely determined by the configuration of the anti-aliasing filter 40, the cutoff frequency of the anti-aliasing filter 40 can be determined from the white level. The cutoff frequency may be determined based on only the signal levels corresponding to some pixels in the frame buffer, or may be determined based on the average value of the signal levels corresponding to the pixels of one screen. Therefore, when a cutoff frequency which causes the highest-frequency component of the image signal is attenuated by 0.1 dB is desired, for example, the setting value of the anti-aliasing filter 40 may be changed so that the white level after AD conversion when inputting the test image signal become 252 without directly calculating the cutoff frequency.

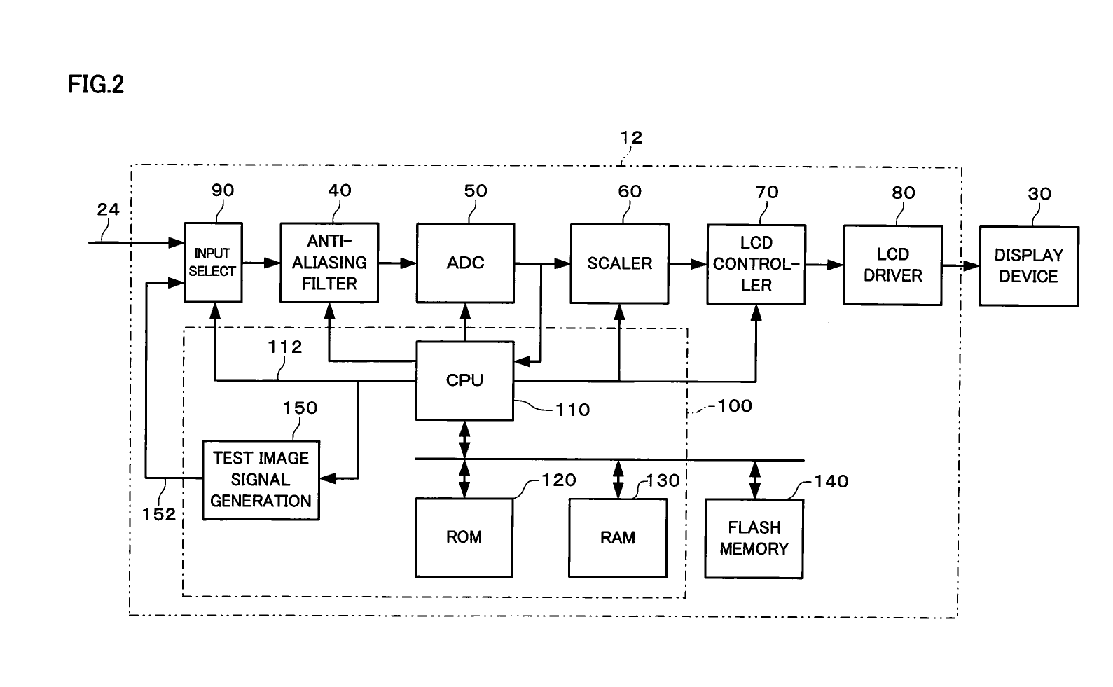

FIG. 2 shows another example of a functional block diagram of the image processing device according to this embodiment. The same elements as in FIG. 1 are indicated by the same symbols. Description of these elements is omitted. An image processing device 12 includes an input select unit 90 which selects an image signal supplied to the anti-aliasing filter 40. The filter calibration unit 100 includes a test image signal generation unit 150 which generates a predetermined test image signal 152. The test image signal 152 may be an image signal which allows the cutoff frequency of the anti-aliasing filter 40 to be determined in the filter calibration mode in the same manner as the test image signal 22 shown in FIG. 1. For example, the test image signal 152 may be an image signal which represents only two colors (i.e., white and black) and alternately represents the two colors in pixel units.

When the image processing device 20 is set in the filter calibration mode, the filter calibration unit 100 controls the input select unit 90 so that the input select unit 90 selects the predetermined test image signal 152 generated by the test image signal generation unit 150. When the image processing device 20 is set in the normal operation mode, the filter calibration unit 100 controls the input select unit 90 so that the input select unit 90 selects the image signal 24 input from the outside. Specifically, when the image processing device 20 is set in the filter calibration mode, the image processing device 20 calibrates the cutoff frequency of the anti-aliasing filter 40 using the test image signal 152. This makes it unnecessary to externally connect the function generator. Therefore, even if the cutoff frequency of the anti-aliasing filter 40 changes due to a change in the resistance of a resistor and the capacitance of a capacitor included in the anti-aliasing filter 40 with the lapse of time, the image processing device 12 can perform self-diagnosis to perform the filter calibration process. For example, a timer may be provided inside or outside the image processing device 12, and a process which sets the image processing device 12 in the filter calibration mode when the image processing device 12 has detected that a predetermined period of time has elapsed may be described in the startup program. Alternatively, the startup count may be stored in the flash memory 140, and a process which sets the image processing device 12 in the filter calibration mode when a predetermined startup count has been reached may be described in the startup program.

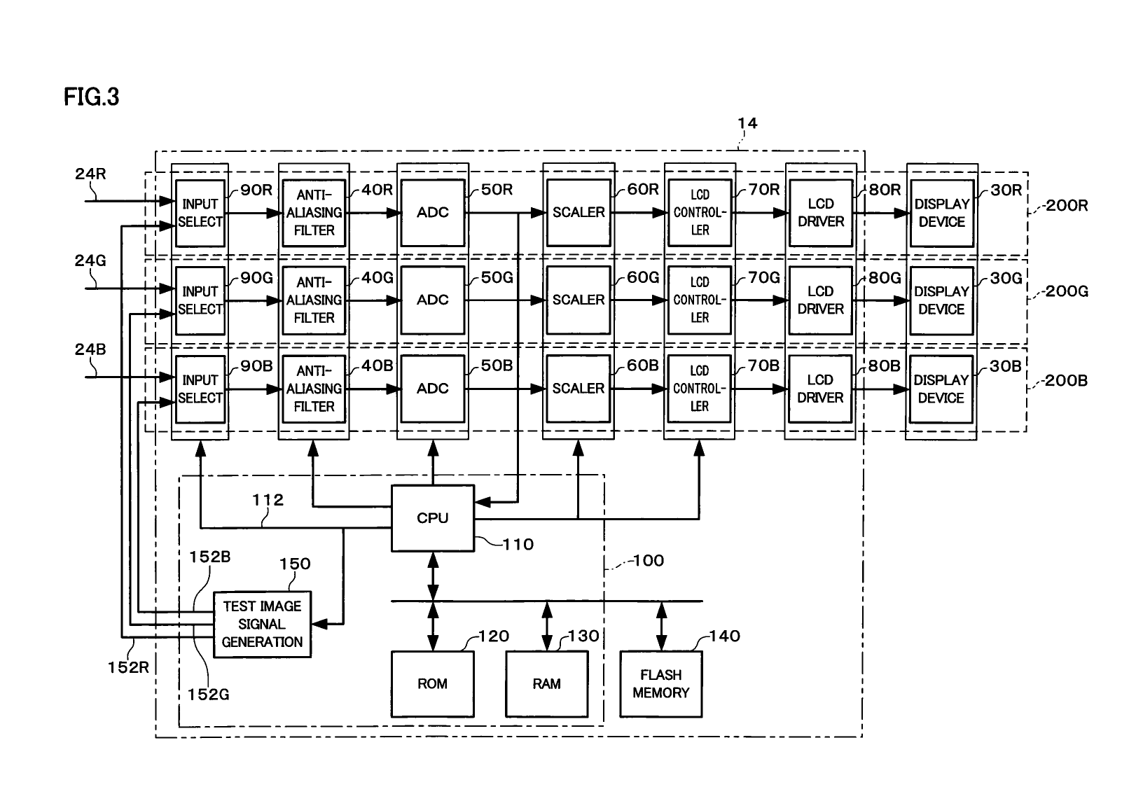

FIG. 3 is a detailed functional block diagram showing the image processing device according to this embodiment shown in FIG. 2. An image processing device 14 may be configured to include three image processing units 200R, 200G, and 200B which independently process R, G, and B image signals, respectively. The image processing units 200R, 200G, and 200B include input select units 90R, 90G, and 90B which select image signals supplied to anti-aliasing filters 40R, 40G, and 40B, respectively. The anti-aliasing filters (40R, 40G, 40B), AD converters (50R, 50G, 50B), scalers (60R, 60G, 60B), LCD controllers (70R, 70G, 70B), LCD drivers (80R, 80G, 80B), and display devices (30R, 30G, 30B) respectively included in the image processing units 200R, 200G, and 200B have the same configurations as the anti-aliasing filter 40, the AD converter 50, the scaler 60, the LCD controller 70, the LCD driver 80, and the display device 30 shown in FIG. 2. Therefore, description thereof is omitted.

The filter calibration unit 100 includes the test image signal generation unit 150 which generates the predetermined test image signal 152. The test image signal generation unit 150 generates test image signals 152R, 152G, and 152B. The test image signals 152R, 152G, and 152B may be image signals which allow the cutoff frequencies of the anti-aliasing filters 40R, 40G, and 40B to be determined in the filter calibration mode. For example, the test image signals 152R, 152G, and 152B may be image signals which represent only two colors at the highest luminance and the lowest luminance and alternately represent the two colors in pixel units. In this case, the image signals input to the anti-aliasing filters 40R, 40G, and 40B in the filter calibration mode have the highest frequency and the largest amplitude, and are most suitable for determining the cutoff frequency.

When the image processing device 14 is set in the filter calibration mode, the filter calibration unit 100 controls the input select units 90R, 90G, and 90B so that the input select units 90R, 90G, and 90B respectively select the predetermined test image signals 152R, 152G, and 152B generated by the test image signal generation unit 150. When the image processing device 14 is set in the normal operation mode, the filter calibration unit 100 controls the input select units 90R, 90G, and 90B so that the input select units 90R, 90G, and 90B respectively select image signals 24R, 24G, and 24B input from the outside. Specifically, when the image processing device 14 is set in the filter calibration mode, the image processing device 14 calibrates the cutoff frequencies of the anti-aliasing filters 40R, 40G, and 40B using the test image signals 152R, 152G, and 152B. This makes it unnecessary to externally connect the function generator. Therefore, even if the cutoff frequency of the anti-aliasing filter 40 changes due to a change in the resistance of a resistor and the capacitance of a capacitor included in each of the anti-aliasing filters 40R, 40G, and 40B with the lapse of time, the image processing device 14 can perform self-diagnosis to perform the filter calibration process. For example, a timer may be provided inside or outside the image processing device 14, and a process which sets the image processing device 12 in the filter calibration mode when the image processing device 14 has detected that a predetermined period of time has elapsed may be described in the startup program. Alternatively, the startup count may be stored in the flash memory 140, and a process which sets the image processing device 14 in the filter calibration mode when a predetermined startup count has been reached may be described in the startup program.

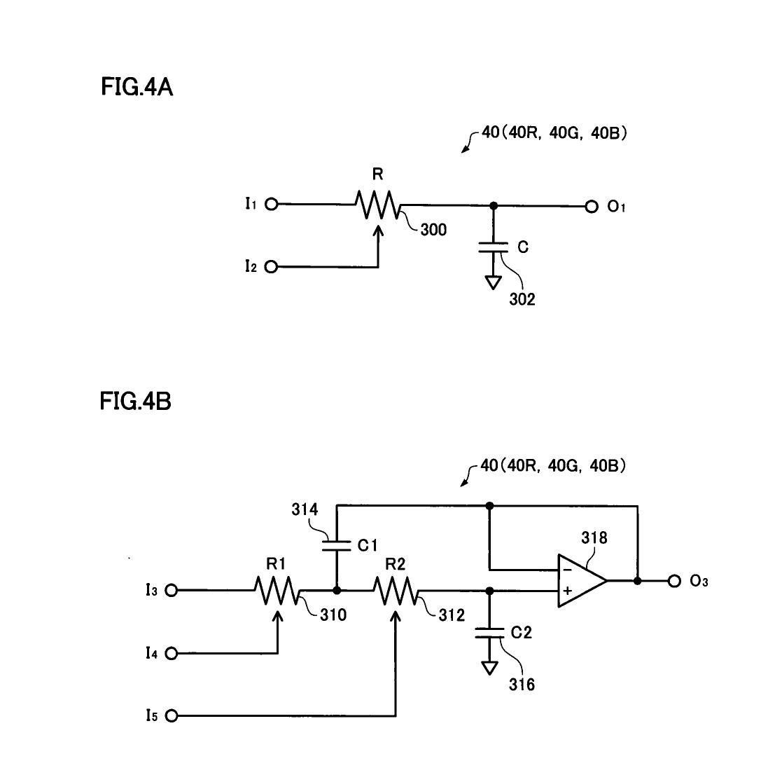

FIG. 4A is a diagram showing a configuration example of the anti-aliasing filter (low-pass filter) of which the cutoff frequency can be variably controlled.

The anti-aliasing filter 40 (40R, 40G, 40B) shown in FIG. 4A includes a variable resistor 300 and a capacitor 302. One end of the variable resistor 300 (resistance: R) is connected to an external input terminal I1, and the other end of the variable resistor 300 is connected to one end of the capacitor 302 (capacitance: C) and an output terminal O1. The other end of the capacitor 302 is grounded. The resistance R of the variable resistor 300 can be variably controlled based on a signal supplied through an external input terminal I2. The anti-aliasing filter 40 (40R, 40G, 40B) functions as a low-pass filter having a cutoff frequency of 1/(2piRC). The cutoff frequency of the anti-aliasing filter 40 can be changed by changing the resistance R of the variable resistor 300. Specifically, the cutoff frequency is decreased by increasing the resistance R of the variable resistor 300, and is increased by decreasing the resistance R of the variable resistor 300. It suffices that the variable resistor 300 have a cutoff frequency which can be variably controlled based on the setting value. For example, the voltage value of the signal supplied through the input terminal I2 may be used as the setting value, and the resistance R may be successively changed based on the voltage value. Alternatively, a select signal supplied through the input terminal I2 may be used as the setting value, and one resistance R may be selected from a plurality of resistances based on the setting value. For example, a 256-position digital potentiometer conforming to an I²C bus interface may be used as the variable resistor 300, and the CPU 110 shown in FIG. 1 may transmit an 8-bit select signal to the variable resistor 300 (digital potentiometer) as the setting value through an I²C bus so that an arbitrary resistance R is selected and set from the 256 positions. The resistance R of the variable resistor 300 is generally changed in order to change the cutoff frequency, as shown in FIG. 4A. Note that only the capacitance C of the capacitor 302 may be changed without changing the resistance R, or both of the resistance R and the capacitance C may be changed.

FIG. 4B is a diagram showing another configuration example of the anti-aliasing filter (low-pass filter) of which the cutoff frequency can be variably controlled. The anti-aliasing filter 40 (40R, 40G, 40B) shown in FIG. 4B includes variable resistors 310 and 312, capacitors 314 and 316, and an operational amplifier 318. One end of the variable resistor 310 (resistance: R1) is connected to an external input terminal I3, and one end of the variable resistor 312 (resistance: R2) and one end of the capacitor 314 (capacitance: C1). The other end of the variable resistor 312 is connected to one end of the capacitor 316 (capacitance: C2) and a non-inverting (+) input terminal of the operational amplifier 318. The other end of the capacitor 314 is connected to an inverting (−) input terminal and an output terminal of the operational amplifier 318. The other end of the capacitor 316 is grounded. The output terminal of the operational amplifier 318 is connected to the inverting (−) input terminal and an external output terminal O3. The resistance R1 of the variable resistor 310 and the resistance R2 of the variable resistor 312 can be variably controlled based on signals supplied through external input terminals 14 and 15, respectively.

The low-pass filter shown in FIG. 4A cannot implement a steep filter characteristic. Therefore, when the AD converter 50 shown in FIG. 1 performs AD conversion at a sampling frequency twice the highest frequency of the image signal, it is necessary to increase the cutoff frequency so that the signal component is not attenuated. As a result, since noise outside the band may not be sufficiently attenuated, it may be difficult to implement an anti-aliasing filter having satisfactory characteristics. On the other hand, the low-pass filter shown in FIG. 4B is a low-pass filter having a second-order Butterworth characteristic called a positive feedback active low-pass filter or a Sallen-Key circuit, and can implement a relatively steep filter characteristic. Therefore, even if the cutoff frequency is decreased, unnecessary high-frequency signal component outside the passband can be sufficiently attenuated without attenuating a signal component within the passband, whereby an anti-aliasing filter having satisfactory characteristics can be implemented. The anti-aliasing filter 40 (40R, 40G, 40B) functions as a low-pass filter having a cutoff frequency of 1/(2piR_{f}C_{f}) by selecting the resistances R1 and R2 and the capacitances C1 and C2 so that R1=R2(=R_{f}), C1=2QC_{f}, and C2=C_{f}/2Q (Q is the gain at the resonance frequency). Therefore, the cutoff frequency can be arbitrarily changed by changing the resistances R1 and R2 of the resistors 310 and 312. The resistances R1 and R2 of the resistors 310 and 312 are generally changed in order to change the cutoff frequency, as shown in FIG. 4B. Note that only the capacitances C1 and C2 of the capacitors 314 and 316 may be changed without changing the resistances R1 and R2 of the resistors 310 and 312, or all of the resistances R1 and R2 and the capacitances C1 and C2 may be changed.

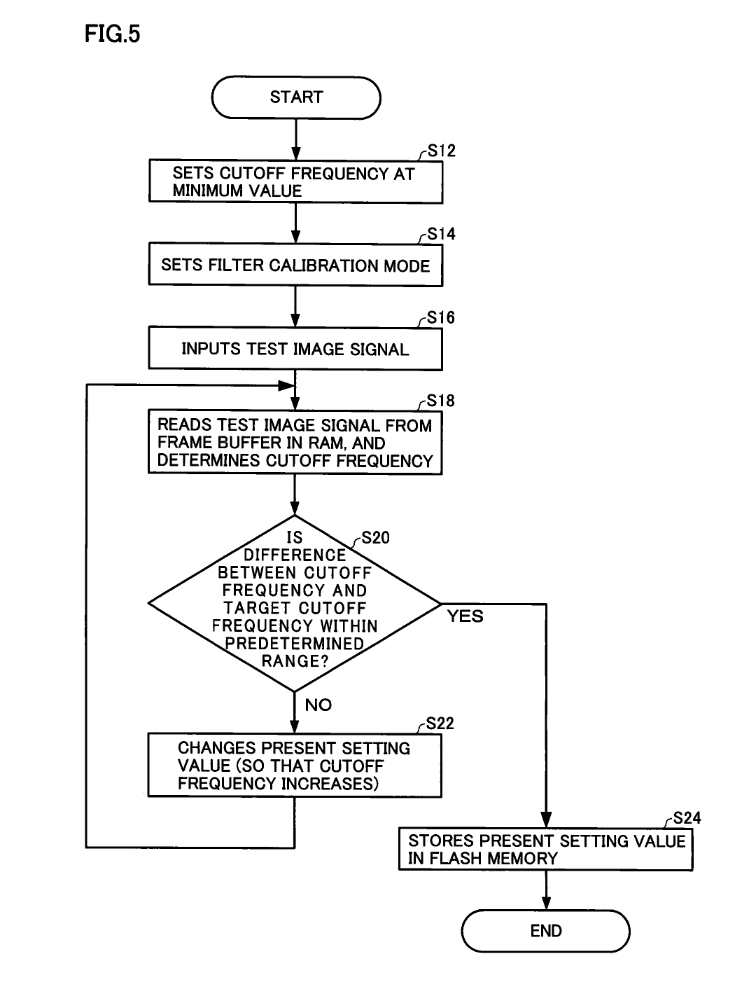

FIG. 5 is a flowchart illustrative of an example of the flow of calibrating the cutoff frequency of the anti-aliasing filter before shipment. The flow shown in FIG. 5 is described below with reference to FIG. 1.

The setting value is set so that the cutoff frequency of the anti-aliasing filter 40 becomes a minimum (step S12). For example, the setting value is set so that the resistance R of the resistor 300 shown in FIG. 4A becomes a maximum.

The image processing device is then set in the filter calibration mode (step S14), and input of the test image signal 22 is started (step S16). The image processing device may be set in the filter calibration mode based on an external terminal setting, or may be automatically set when power is supplied to the image processing device, for example. The test image signal 22 is then continuously input until the calibration process is completed. The test image signal 22 passes through the anti-aliasing filter 40 and the AD converter 50, and the test image signal converted into a digital signal is sequentially written into the frame buffer in the storage area of the RAM 130.

The CPU 110 reads the test image signal written into the frame buffer at a predetermined timing based on the filter calibration program stored in the ROM 120, and determines the cutoff frequency based on the present setting value (step S18). Specifically, the CPU 110 can easily determine the cutoff frequency from the digital value written into the frame buffer when inputting the test image signal containing a highest-frequency component (e.g., image signal which alternately represents white and black in pixel units).

When the CPU 110 has determined that the difference between the cutoff frequency and the target cutoff frequency is within a predetermined range (YES in step S20), the CPU 110 stores the present setting value in the flash memory (step S24), and finishes the calibration process. When the CPU 110 has determined that the difference between the cutoff frequency and the target cutoff frequency is not within a predetermined range (NO in step S20), the CPU 110 changes the present setting value so that the cutoff frequency increases (step S22). The CPU 110 continues the calibration process until the difference between the cutoff frequency and the target cutoff frequency falls within a predetermined range. The target cutoff frequency is determined corresponding to each image processing device depending on the type of filter, the tradeoff relationship between signal attenuation and noise removal, and the like.

In FIG. 5, a setting value which causes the cutoff frequency to become a minimum is selected as the initial value in the step S12. Note that another value may also be selected. For example, a setting value which causes the cutoff frequency to become a maximum may be selected as the initial value, and the CPU 110 may change the setting value so that the cutoff frequency decreases instead of the process in the step S22. In order to reduce the time required for the calibration process, a setting value which causes the cutoff frequency to coincide with the target cutoff frequency when the resistance and the capacitance are minimized due to variations in resistance and capacitance during production (i.e., the cutoff frequency becomes a maximum) may be selected as the initial value. A design target setting value may be set as the initial value. The setting value may be changed so that the cutoff frequency increases when the cutoff frequency is lower than the calibration target value, and may be changed so that the cutoff frequency decreases when the cutoff frequency is higher than the calibration target value instead of the process in the step S22. Alternatively, a setting value which causes the cutoff frequency to coincide with the calibration target value may be directly calculated based on the cutoff frequency according to the present setting value determined in the step S18.

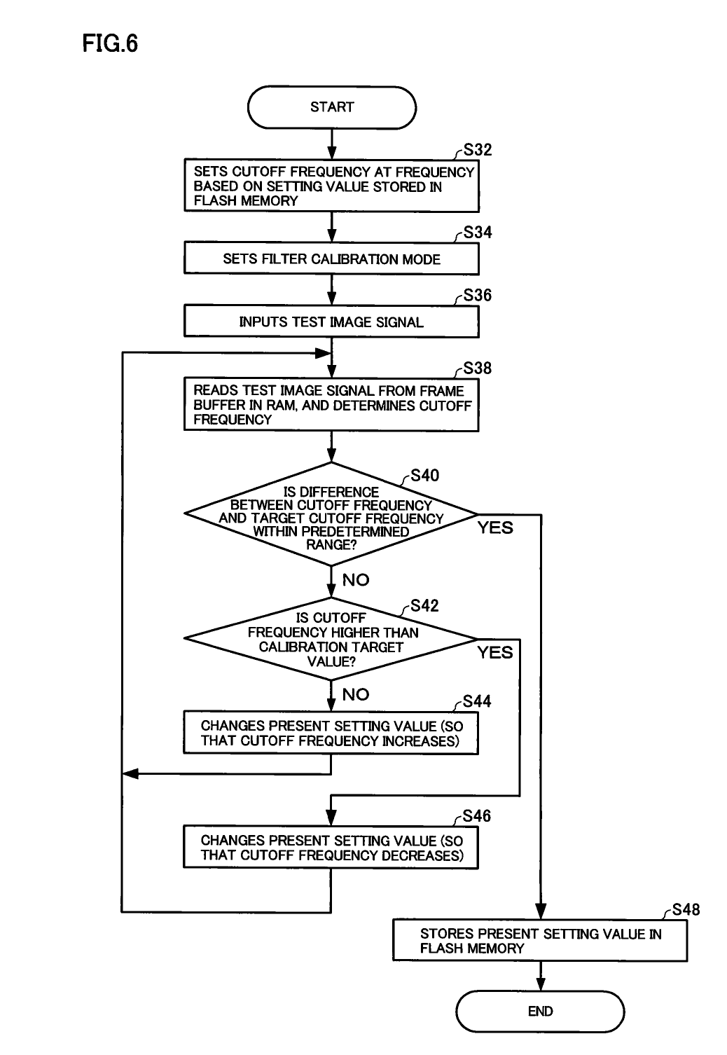

FIG. 6 is a flowchart illustrative of an example of the flow of repeating calibration of the cutoff frequency of the anti-aliasing filter after calibrating the cutoff frequency of the anti-aliasing filter. The flow shown in FIG. 6 is described below with reference to FIG. 1.

The image processing device is set in the filter calibration mode (step S34), and input of the test image signal 22 is started (step S36). The test image signal 22 is then continuously input until the calibration process is completed. The test image signal 22 passes through the anti-aliasing filter 40 and the AD converter 50, and the test image signal converted into a digital signal is sequentially written into the frame buffer in the storage area of the RAM 130.

The CPU 110 reads the test image signal written into the frame buffer at a predetermined timing based on the filter calibration program stored in the ROM 120, and determines the cutoff frequency based on the present setting value (step S38).

When the CPU 110 has determined that the difference between the cutoff frequency and the target cutoff frequency is within a predetermined range (YES in step S40), the CPU 110 stores the present setting value in the flash memory (step S48), and finishes the calibration process. When the CPU 110 has determined that the difference between the cutoff frequency and the target cutoff frequency is not within a predetermined range (NO in step S40), when the cutoff frequency is lower than the target cutoff frequency (NO in step S42), the CPU 110 changes the present setting value so that the cutoff frequency increases (step S44). On the other hand, when the cutoff frequency is higher than the target cutoff frequency (YES in step S42), the CPU 110 changes the present setting value so that the cutoff frequency decreases (step S46). The CPU 110 continues the calibration process until the difference between the cutoff frequency and the target cutoff frequency falls within a predetermined range.

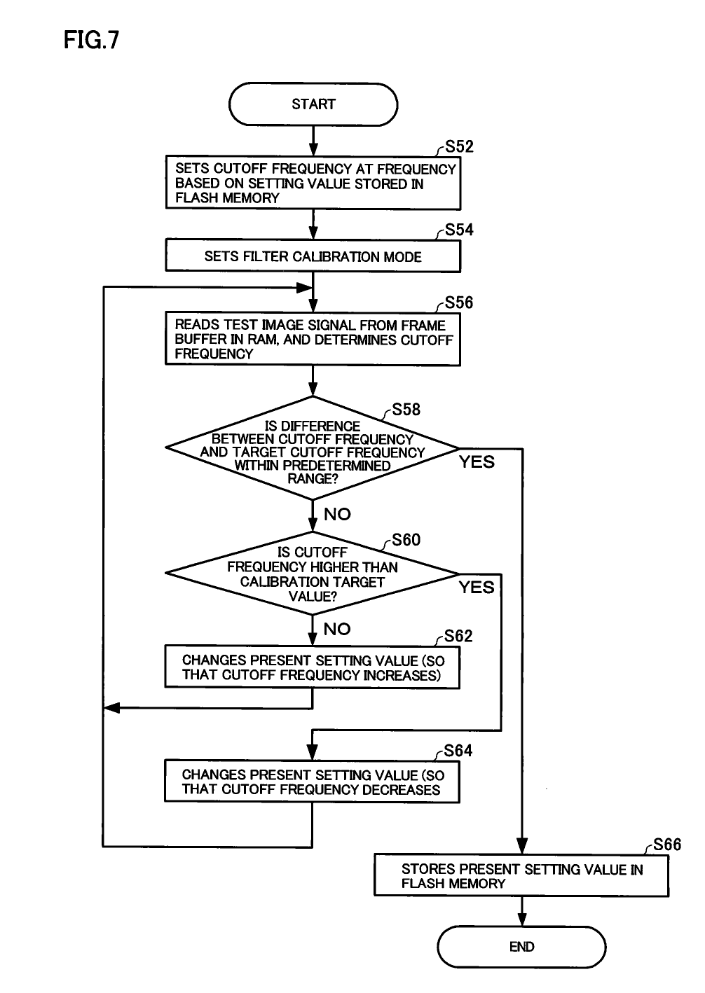

FIG. 7 is a flowchart illustrative of an example of the flow of calibrating the cutoff frequency of the anti-aliasing filter when the image processing device according to this embodiment includes the test image signal generation unit. The flow shown in FIG. 7 is described below with reference to FIG. 2.

The image processing device is set in the filter calibration mode (step S54). When the image processing device is set in the filter calibration mode, the CPU 110 outputs a filter calibration control signal 112. The test image signal generation unit 150 starts generating the test image signal 152 based on the control signal 112, and the input select unit 90 selects the test image signal 152 and starts supplying the test image signal 152 to the anti-aliasing filter 40. The test image signal 152 is then continuously generated and supplied to the anti-aliasing filter 40 until the calibration process is completed. The test image signal 152 passes through the anti-aliasing filter 40 and the AD converter 50, and the test image signal converted into a digital signal is sequentially written into the frame buffer in the storage area of the RAM 130.

The CPU 110 reads the test image signal written into the frame buffer at a predetermined timing based on the filter calibration program stored in the ROM 120, and determines the cutoff frequency based on the present setting value (step S56).

When the CPU 110 has determined that the difference between the cutoff frequency and the target cutoff frequency is within a predetermined range (YES in step S58), the CPU 110 stores the present setting value in the flash memory (step S66), and finishes the calibration process. When the CPU 110 has determined that the difference between the cutoff frequency and the target cutoff frequency is not within a predetermined range (NO in step S58), when the cutoff frequency is lower than the target cutoff frequency (NO in step S60), the CPU 110 changes the present setting value so that the cutoff frequency increases (step S62). On the other hand, when the cutoff frequency is higher than the target cutoff frequency (YES in step S60), the CPU 110 changes the present setting value so that the cutoff frequency decreases (step S64). The CPU 110 continues the calibration process until the difference between the cutoff frequency and the target cutoff frequency falls within a predetermined range.

2. Electronic Instrument

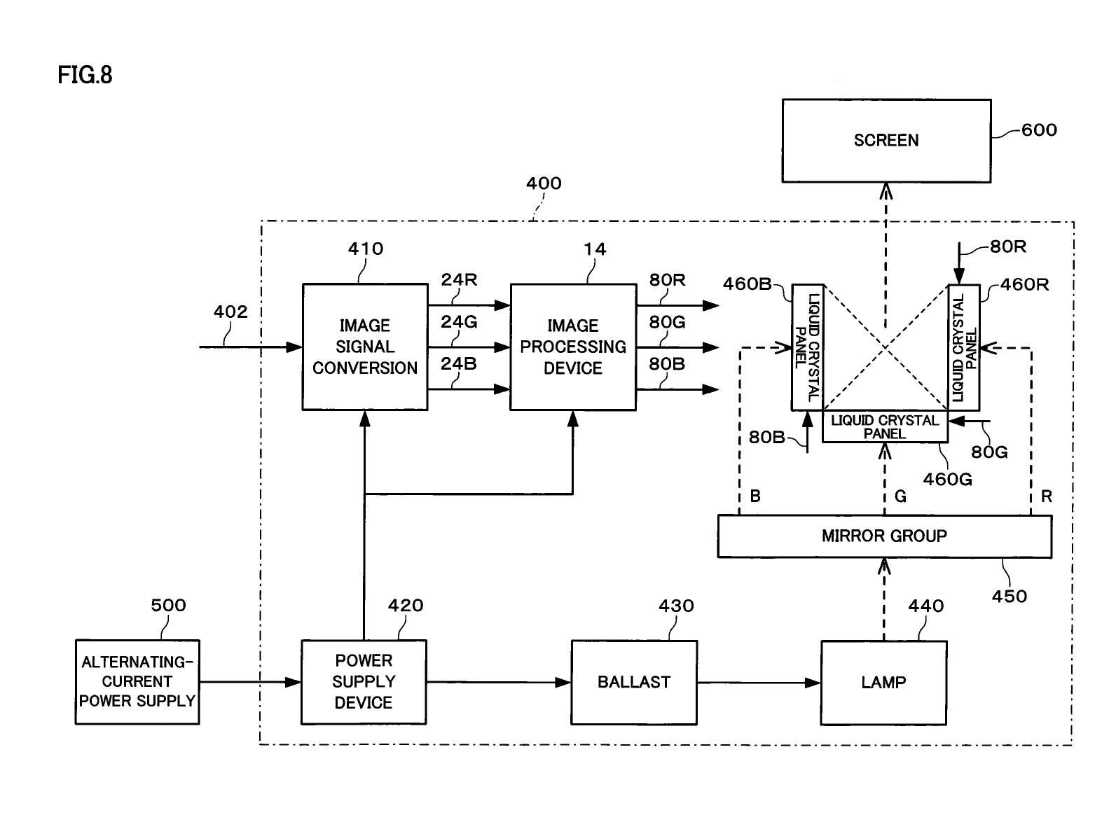

FIG. 8 shows a configuration example of a projector as an example of an electronic instrument according to one embodiment of the invention. A projector 400 includes an image processing device 14, an image signal conversion unit 410, a power supply device 420, a ballast circuit 430, a lamp 440, a mirror group 450, and liquid crystal panels 460R, 460G, and 460B. The image signal conversion unit 410 converts an externally input image signal 402 (e.g., luminance-color difference signal or digital RGB signal) into an analog RGB signal to generate image signals 24R, 24G, and 24B, and supplies the image signals 24R, 24G, and 24B to the image processing device 14. The image processing device 14 processes the image signals 24R, 24G, and 24B, and outputs drive signals 80R, 80G, and 80B for driving the liquid crystal panels 460R, 460G, and 460B, respectively.

The power supply device 420 converts an alternating-current voltage supplied from an external alternating-current power supply 500 into a constant direct-current voltage, and supplies the direct-current voltage to the image processing device 14 and the image signal conversion unit 410 on a secondary-side of a transformer (not shown; included in the power supply device 420) and to the ballast circuit 430 on a primary-side instrument of the transformer. The ballast circuit 430 causes a breakdown during startup by generating a high voltage between terminals of the lamp 440 to form a discharge path, and then supplies a lamp current for the lamp 440 to maintain discharge. A beam emitted from the lamp 440 is separated into three R, G, and B beams through two dichroic mirrors included in the mirror group 450. The beams are reflected by other mirrors to enter the liquid crystal panels 460R, 460G, and 460B. The liquid crystal panels 460R, 460G, and 460B display images based on the drive signals 80R, 80G, and 80B, respectively. The R, G, and B beams pass through the liquid crystal panels 460R, 460G, and 460B and are synthesized by a prism, and the resulting image is displayed on a screen 600.

The electronic instrument according to the embodiment of the invention is not limited to the projector shown in FIG. 8, but may be an arbitrary electronic instrument in which the image processing device includes the anti-aliasing filter. For example, electronic instruments such as a plasma television, a liquid crystal television, and a rear projection television may be considered.

The invention is not limited to the above embodiments. Various modifications and variations may be made within the scope of the invention.

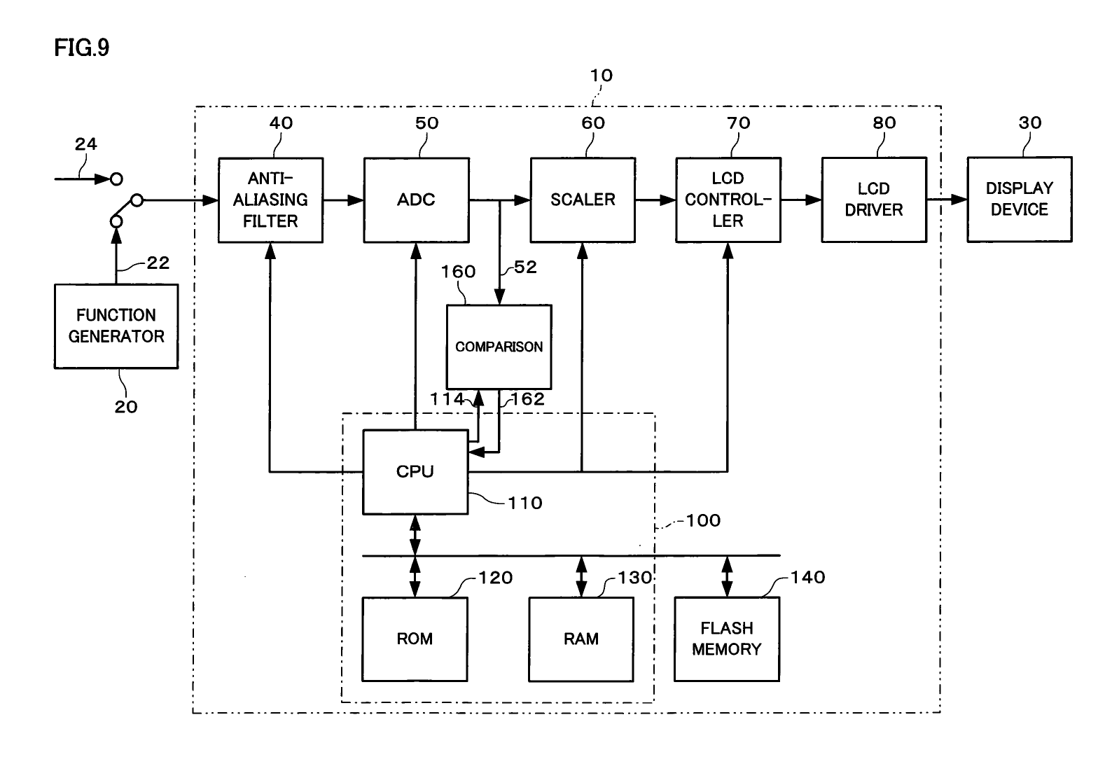

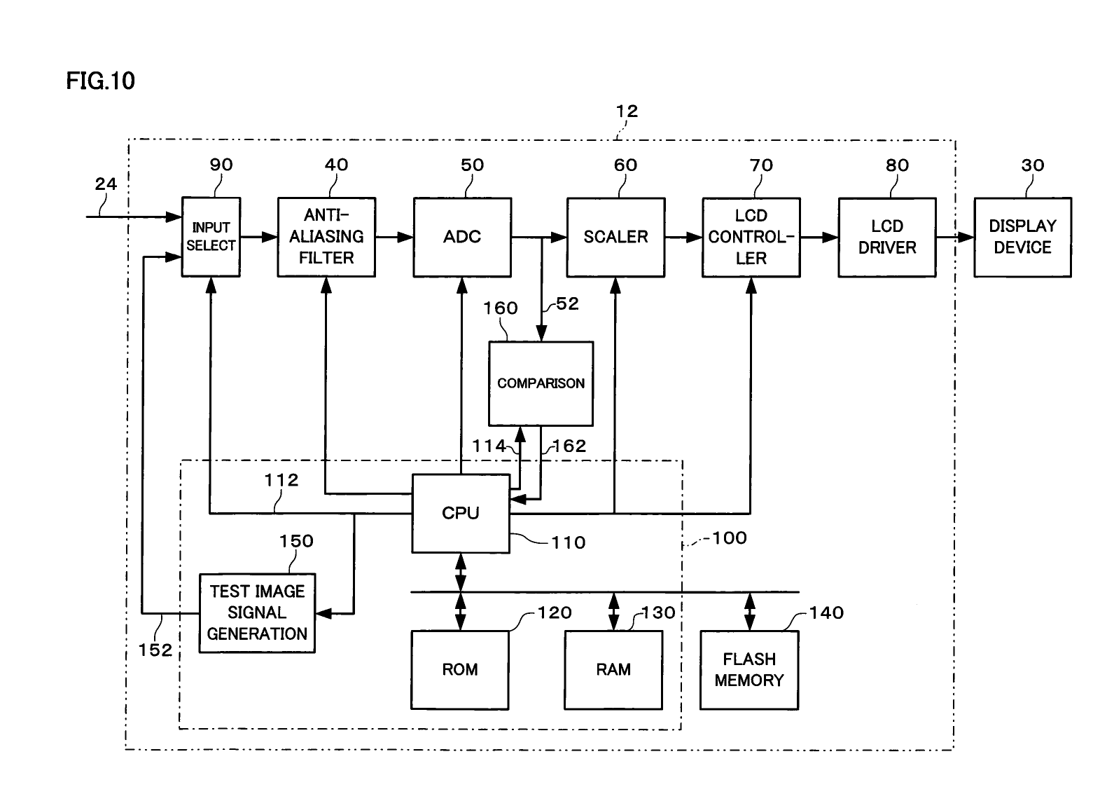

For example, as shown in FIGS. 9 and 10, the image processing devices shown in FIGS. 1 and 2 may include a comparison circuit 160 (dedicated hardware) which functions as a comparison unit. The comparison circuit 160 compares an output 52 from the AD converter 50 when the test image signal 22 or 152 is input to the anti-aliasing filter 40 with calibration reference data 114 for the cutoff frequency of the anti-aliasing filter 40. The filter calibration unit 100 (CPU 110) may calibrate the cutoff frequency of the anti-aliasing filter 40 based on a comparison result 162 of the comparison circuit 160.

For example, an expected value (e.g., maximum value or root-mean-square value) of the amplitude level of the output 52 from the AD converter 50 when a test image signal corresponding to each standard (e.g., 480i, 480p, 720p, 1080i, or 1080p) is input to the anti-aliasing filter 40 may be stored in advance in the ROM 120 or the like as the calibration reference data corresponding to each standard. When the image processing device is set in the filter calibration mode, the CPU 110 may read the corresponding calibration reference data from the ROM 120 or the like at a predetermined timing, and the comparison circuit 160 may compare the maximum value, the root-mean-square value, or the like of the amplitude level of the output 52 from the AD converter 50 with the calibration reference data 114. The filter calibration unit 100 (CPU 110) may calibrate the cutoff frequency of the anti-aliasing filter 40 based on the comparison result 162 of the comparison circuit 160 by changing the setting value so that the cutoff frequency of the anti-aliasing filter 40 increases when the maximum value, the root-mean-square value, or the like of the amplitude level of the output from the AD converter 50 is smaller than the calibration reference data, and changing the setting value so that the cutoff frequency of the anti-aliasing filter 40 decreases when the maximum value, the root-mean-square value, or the like of the amplitude level of the output from the AD converter 50 is larger than the calibration reference data, for example. When the image processing device 10 or 12 includes the comparison circuit 160, the load imposed on the CPU 110 during the filter calibration process can be reduced.

The invention includes various other configurations substantially the same as the configurations described in the embodiments (in function, method and result, or in objective and result, for example). The invention also includes a configuration in which an unsubstantial portion in the described embodiments is replaced. The invention also includes a configuration having the same effects as the configurations described in the embodiments, or a configuration able to achieve the same objective. Further, the invention includes a configuration in which a publicly known technique is added to the configurations in the embodiments.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. An image processing device comprising:
an anti-aliasing filter, a cutoff frequency of the anti-aliasing filter being variable;
an analog-digital (AD) converter which converts an analog signal output from the anti-aliasing filter into a digital signal, and outputs the digital signal; and
a filter calibration unit which calibrates the cutoff frequency of the anti-aliasing filter based on an output from the AD converter when a predetermined test image signal is input to the anti-aliasing filter.

2. The image processing device as defined in claim 1, comprising:
a comparison unit which compares the output from the AD converter when the predetermined test image signal is input to the anti-aliasing filter with calibration reference data for the cutoff frequency,
the filter calibration unit calibrating the cutoff frequency based on a comparison result of the comparison unit.

3. The image processing device as defined in claim 1,
wherein the filter calibration unit calibrates the cutoff frequency of the anti-aliasing filter by changing a setting value of the cutoff frequency when the filter calibration unit has determined that a difference between the cutoff frequency and a target cutoff frequency is not within a predetermined range.

4. The image processing device as defined in claim 2,
wherein the filter calibration unit calibrates the cutoff frequency of the anti-aliasing filter by changing a setting value of the cutoff frequency when the filter calibration unit has determined that a difference between the cutoff frequency and a target cutoff frequency is not within a predetermined range.

5. The image processing device as defined in claim 1,
wherein the filter calibration unit writes a setting value of the calibrated cutoff frequency of the anti-aliasing filter into a nonvolatile memory.

6. The image processing device as defined in claim 2,
wherein the filter calibration unit writes a setting value of the calibrated cutoff frequency of the anti-aliasing filter into a nonvolatile memory.

7. The image processing device as defined in claim 3,
wherein the filter calibration unit writes a setting value of the calibrated cutoff frequency of the anti-aliasing filter into a nonvolatile memory.

8. The image processing device as defined in claim 1,
wherein the predetermined test image signal represents an image of two colors, the two colors being alternately represented in pixel units in the image.

9. The image processing device as defined in claim 2,
wherein the predetermined test image signal represents an image of two colors, the two colors being alternately represented in pixel units in the image.

10. The image processing device as defined in claim 3,
wherein the predetermined test image signal represents an image of two colors, the two colors being alternately represented in pixel units in the image.

11. The image processing device as defined in claim 8,
wherein the two colors of the image represented by the test image signal are white and black.

12. The image processing device as defined in claim 9,
wherein the two colors of the image represented by the test image signal are white and black.

13. The image processing device as defined in claim 1, comprising:
a mode switch unit which switches a mode of the image processing device from a normal operation mode for performing normal image signal processing to a filter calibration mode for calibrating the cutoff frequency of the anti-aliasing filter based on a predetermined event.

14. The image processing device as defined in claim 2, comprising:
a mode switch unit which switches a mode of the image processing device from a normal operation mode for performing normal image signal processing to a filter calibration mode for calibrating the cutoff frequency of the anti-aliasing filter based on a predetermined event.

15. The image processing device as defined in claim 13, comprising:
an input select unit which selects an image signal to be supplied to the anti-aliasing filter,
wherein the filter calibration unit includes a test image signal generation unit which generates the predetermined test image signal, controls the input select unit so that the input select unit selects the predetermined test image signal generated by the test image signal generation unit in the filter calibration mode, and controls the input select unit so that the input select unit selects an externally supplied image signal in the normal operation mode.

16. The image processing device as defined in claim 14, comprising:
an input select unit which selects an image signal to be supplied to the anti-aliasing filter,
wherein the filter calibration unit includes a test image signal generation unit which generates the predetermined test image signal, controls the input select unit so that the input select unit selects the predetermined test image signal generated by the test image signal generation unit in the filter calibration mode, and controls the input select unit so that the input select unit selects an externally supplied image signal in the normal operation mode.

17. The image processing device as defined in claim 13,
wherein the mode switch unit switches the mode of the image processing device from the normal operation mode to the filter calibration mode when a predetermined condition has been satisfied during startup after power has been supplied to the image processing device, and switches the mode of the image processing device from the filter calibration mode to the normal operation mode when the filter calibration unit has completed calibration of the cutoff frequency of the anti-aliasing filter.

18. The image processing device as defined in claim 14,
wherein the mode switch unit switches the mode of the image processing device from the normal operation mode to the filter calibration mode when a predetermined condition has been satisfied during startup after power has been supplied to the image processing device, and switches the mode of the image processing device from the filter calibration mode to the normal operation mode when the filter calibration unit has completed calibration of the cutoff frequency of the anti-aliasing filter.

19. An electronic instrument comprising the image processing device as defined in claim 1, an input unit which inputs an image signal, and a display unit which displays the image signal.

20. A method of calibrating an anti-aliasing filter which variably controls a cutoff frequency based on a setting value, the method comprising:
switching a mode from a normal operation mode for performing normal image signal processing to a filter calibration mode for calibrating the cutoff frequency of the anti-aliasing filter based on a predetermined event; and
calibrating the cutoff frequency of the anti-aliasing filter by changing the setting value when a difference between the cutoff frequency of the anti-aliasing filter and a target cutoff frequency has been determined not to be within a predetermined range based on a digital signal obtained by analog-digital-conversion of an analog signal output from the anti-aliasing filter when a predetermined test image signal has been input to the anti-aliasing filter.
